(19) United States
(12) Patent Application Publication
(10) Pub. No.: US 2026/0147843 A1
(43) Pub. Date: May 28, 2026

(54) Document Scoring System

(71) Applicants: Massachusetts Institute of Technology, Cambridge, MA (US); UCL BUSINESS LTD, London (GB)

(72) Inventors: Tali Sharot, Brookline, MA (US); Christopher Kelly, Somerville, MA (US)

(21) Appl. No.: 19/122,009

(22) PCT Filed: Oct. 17, 2023
(86) PCT No.: PCT/US2023/035274

§ 371 Date: Apr. 17, 2025

Related U.S. Application Data
(60) Provisional application No. 63/416,686, filed on Oct. 17, 2022.

(51) Int. Cl. G06F 16/9535; G06F 16/951

(52) U.S. Cl. CPC G06F 16/9535; G06F 16/951

(57) ABSTRACT

A method includes receiving data characterizing a number of documents, including data associating each document with a number of utility scores. Each utility score characterizes a different type of utility of the document to a consumer of the document. A subset of the documents is selected for presentation to a user, the selecting being based at least in part on the respective utility scores associated with each of the documents and the subset of documents is provided for presentation to the user.

### CROSS-REFERENCES TO RELATED APPLICATIONS

This application claims the benefit of U.S. Provisional Patent Application No. 63/416,686 filed on Oct. 17, 2022. The entire contents of U.S. Application No. 63/416,686 are incorporated herein by reference.

### BACKGROUND OF THE INVENTION

This invention relates to a system, methods, and software products for informing users about characteristics of content (e.g., webpage documents) the users consume or may consume.

Approximately eight billion search engine queries are submitted daily by individuals who seek to gain knowledge and make informed decisions. However, in most cases, search results are shaped by opaque algorithms that do not necessarily align with users'goals. Consequently, individuals may dedicate countless hours to absorbing information that may not yield practical benefits, and in some cases, may have a detrimental effect on their well-being (e.g., when negatively valanced content is consumed).

### SUMMARY OF THE INVENTION

Aspects described herein quantify cognitive, instrumental, and hedonic characteristics of content (e.g., webpages) and use those quantities to help an individual effectively and deliberately seek and select information they want to consume. In the context of web browsing, if an individual wants to gain a deeper understanding of a specific topic, a cognitive utility score (aka knowledge score) can guide their web-browsing decision. In contrast, if they want information that can guide their action, they can consider an instrumental utility score (aka usefulness score) instead.

Moreover, research shows that exposure to negative information induces a negative mood. Thus, being made aware of the affective properties of a webpage (i.e., hedonic utility) before engaging with it can help users regulate their emotional state. Specifically, aspects may allow users to reorder a search engine results page by the valence (aka emotion score) or by specific emotions (i.e., sadness, happiness, anger etc.) or filter the results to exclude webpages that fall outside a certain range of scores. For example, a user may select not to have webpages with very negative content presented on the search engine results page and its direct access can be blocked. Likewise, webpages can be filtered by specific emotions, for example, users may want to block webpages that are very sad or very angry in sentiment. Such tools may help mitigate the negative impact of internet browsing on well-being. The same principle can be applied to the other utility scores by allowing filtering thresholds to be manually set by the user.

Furthermore, just as people may be interested in the nutritional properties of food they consume over a period of time (e.g., how much sugar, protein, and fat was consumed in a weekend) in order to balance future nutritional choices and optimize their physical condition, a user may want to monitor the characteristics of information they consumed online over a certain time period (e.g., a week). Aspects described herein may use this information to guide a user's browsing behavior according to their predetermined goals and optimize their well-being.

The nature of how webpages are interpreted and rated is of course subjective. For instance, a webpage that is perceived as positive by one person may be perceived negatively by another. Yet, as the results detailed below demonstrate there is nonetheless high agreement across users on average regarding the valence (hedonic), actionability (instrumental), and potential knowledge (cognitive) enhancement of webpages. This suggests that despite subjectivity and individual differences, it is possible to effectively capture a shared perception that is relevant to many users and can be leveraged. Just as mean ratings of products (books, movies, items) are often helpful despite their subjective nature, ‘on average’ scores of webpages can be valuable in guiding users'online information consumption, allowing them to engage with information that aligns with their goals and preferences.

In a general aspect, a method includes receiving data characterizing a number of documents, including data associating each document with a number of utility scores. Each utility score characterizes a different type of utility of the document to a consumer of the document. A subset of the documents is selected for presentation to a user, the selecting being based at least in part on the respective utility scores associated with each of the documents and the subset of documents is provided for presentation to the user.

In another general aspect, a process automatically quantifies and presents key properties of documents to the user. These include (i) affective properties, such as the valence (positive, negative) and the basic emotions (sadness, happiness, anger etc.) of the webpage (hereafter ‘hedonic utility’); (ii) the ability of the information on the webpage to guide decisions and actions (hereafter ‘instrumental utility’); (iii) and the ability of the information on a webpage to increase knowledge/understanding of a topic (hereafter ‘cognitive utility’). In another aspect, a functionality of the process is described where these quantified features (hereafter ‘utility scores’) are presented on each webpage visited. In another embodiment of the present invention, a functionality of the process is described where these utility scores are presented alongside each webpage link on a search engine results page. In another embodiment of the present invention, a functionality of the process is described where the search engine results page is reordered by a combination of the utility scores. In another embodiment of the present invention, a functionality of the process is described where documents can be filtered out and have their access blocked if a specific utility score does not fit within a defined range. In another embodiment of the present invention, a functionality of the process is described where individuals receive a summary of the utility scores of documents they have visited over a defined time period.

In another aspect, the instrumental and cognitive utility scores are assessed by training a supervised machine learning model. In other embodiments, the instrumental and cognitive utility scores are assessed by training different supervised machine learning models, respectively.

In another aspect, a process automatically quantifies and presents key properties of documents to the user. These include (i) affective properties, such as the valence (positive, negative) and the basic emotions (sadness, happiness, anger etc.) of the webpage (hereafter ‘hedonic utility’); (ii) the ability of the information on the webpage to guide decisions and actions (hereafter ‘instrumental utility’); (iii) and the ability of the information on a webpage to increase knowledge/understanding of a topic (hereafter ‘cognitive utility’). In another embodiment of the present invention, a functionality of the process is described where these quantified features (hereafter ‘utility scores’) are presented on each webpage visited. In another embodiment of the present invention, a functionality of the process is described where these utility scores are presented alongside each webpage link on a search engine results page. In another embodiment of the present invention, a functionality of the process is described where the search engine results page is reordered by a combination of the utility scores. In another embodiment of the present invention, a functionality of the process is described where documents can be filtered out and have their access blocked if a specific utility score does not fit within a defined range. In another embodiment of the present invention, a functionality of the process is described where individuals receive a summary of the utility scores of documents they have visited over a defined time period.

In another general aspect, a method includes receiving data characterizing a number of documents, including data associating each document with a number of utility scores. Each utility score characterizes a different type of utility of the document to a consumer of the document. A subset of documents is selected for presentation to a user, the selecting being based at least in part on the respective utility scores associated with each of the documents and the subset of documents is provided for presentation to the user.

Aspects may include one or more of the following features.

The method may include ordering the selected subset of documents according to the respective utility scores associated with each of the documents prior to providing the subset of documents for presentation to the user. The utility scores may include at least two of a first utility score that characterizes a hedonic utility of a document to a consumer of the document, a second utility score that characterizes an instrumental utility of the document to a consumer of the document, and a third utility score that characterizes a cognitive utility of the document to a consumer of the document.

The presentation of utility scores and/or the selected subset of documents may include using a graphical user interface.

The hedonic utility of a document to a consumer of the document may characterize affective properties of the document to the consumer of the document including valence and emotion properties of the document to the consumer of the document. The instrumental utility of a document to a consumer of the document may characterize an ability of the document to guide decisions or actions of the consumer. The cognitive utility of a document to a consumer of the document may characterize an ability of the document to increase a knowledge or understanding of a topic related to the document. The selecting of a subset of documents for presentation to a user may be based at least in part on user-defined desired utility scores.

The data characterizing the documents may include an index for a search engine. Presenting the subset of the documents to the user may include presenting a document to the user along with its associated utility scores. The data characterizing the documents may be determined by processing the documents in bulk to identify the utility scores for the documents. The data characterizing the documents may be determined as new documents are received from a stream of documents.

In another general aspect, a method includes receiving data characterizing a number of documents consumed by a user, determining, for each document, an associated number of utility scores, wherein each utility score characterizes a different type of utility of the document to a consumer of the document, determining an information consumption score, the determining including aggregating the associated scores for the documents, and providing the information consumption score for presentation to the user.

Aspects may have the following advantages.

For example, the systems and methods can be applied to analyze different types of documents including written documents such as webpages, chat threads, book chapters, and AI-generated writings, as well as non-written documents such as audio and video recordings. The graphic use interface of the Google Chrome plugin software is very easy to use for ordinary users. The described tools may be used to monitor an individual's or a group of individuals' reading patterns and mental state over any period of time. They can also be used to find differences in estimated hedonic, instrumental, and cognitive utilities among different people, which may be helpful for medical personnel to identify psychiatric symptoms and conditions of patients.

Aspects of the invention may be useful in helping government officials identify the costs and benefits of information disclosure policies. They could also trigger ideas for making information more attractive, thus increasing the likelihood that people will read leaflets and labels and benefit from them. Considering the expected hedonic, cognitive, and instrumental utility of information using these methods can also reveal how information should be framed in order to maximize use. Regulators may use these methods to consider individual differences in information-seeking patterns and the influence of information on welfare due to mental health issues or demographic characteristics.

Other features and advantages of the invention are apparent from the following description and from the claims.

### BRIEF DESCRIPTION OF THE DRAWINGS

FIG. 1 depicts a process for determining the utility scores of a webpage in accordance with some embodiments.

FIG. 2 depicts the presentation of utility scores alongside search engine results in line with some embodiments.

FIG. 3 depicts the reordering of search engine results by utility scores in line with some embodiments.

FIG. 4 depicts the presentation and/or removal of webpages by utility scores in line with some embodiments.

FIG. 5 depicts the presentation of a summary of utility scores to the user over a set period of time with some embodiments.

FIG. 6 depicts a browser plugin application for providing utility scores in line with some embodiments.

FIG. 7 depicts presentation of utility scores using a Google Chrome plugin software.

FIG. 8 depicts a method for automatically quantifying and presenting a set of utility scores associated with a webpage being accessed by a user via a browser process executing on the computing device.

### DETAILED DESCRIPTION

### 1 Overview

Research on the diverse motives that lead people to seek or avoid information has revealed that information can alter people's actions, affect, and cognition in both positive and negative ways. It has been shown that people are more likely to seek information when they believe the information (i) can guide their actions and decisions (i.e., has high instrumental utility), (ii) will improve their affective state (i.e., has high hedonic utility) and (iii) improve their understanding of a topic (i.e., has high cognitive utility). Individuals often prioritize one of these factors over the other two when seeking information.

In some examples, the instrumental utility of the information represents the expected impact of information on the person's action (e.g., “will the knowledge help, hinder, or have no influence on my ability to make decisions to increase reward and avoid harm?”). The hedonic utility represents the expected impact of the information on the person's affect (e.g., “will the information induce positive or negative feelings or have no influence on my affect?”). The cognitive utility represents an expected impact of the information on the person's cognition (e.g., “will the information improve my ability to comprehend and anticipate reality?”). Each of the factors can be positive (i.e., increasing information seeking), negative (i.e., increasing information avoidance), or zero (i.e., inducing indifference). Further explanation of the instrumental, hedonic, and cognitive utilities is provided below.

In general, people use their estimates of the utilities to determine a value for the information, which triggers information-seeking (if the integrated value is sufficiently positive), its active avoidance (if the integrated value is sufficiently negative), or neither (i.e., indifference). People weigh each of these factors differently, such that the different factors influence their decision to seek or avoid information to different degrees.

The systems, methods, and software products described herein leverage this understanding of human information-seeking behavior to provide users of computing devices with information about the hedonic, instrumental, and cognitive characteristics of content (e.g., webpages). In some examples, doing so helps users decide which content to consume, while avoiding the detrimental effects of consuming unwanted content. As is described in greater detail below, in the context of web browsing, aspects make users aware of the hedonic, cognitive, and instrumental utilities of webpages so they can take them into account when deciding which webpage to visit.

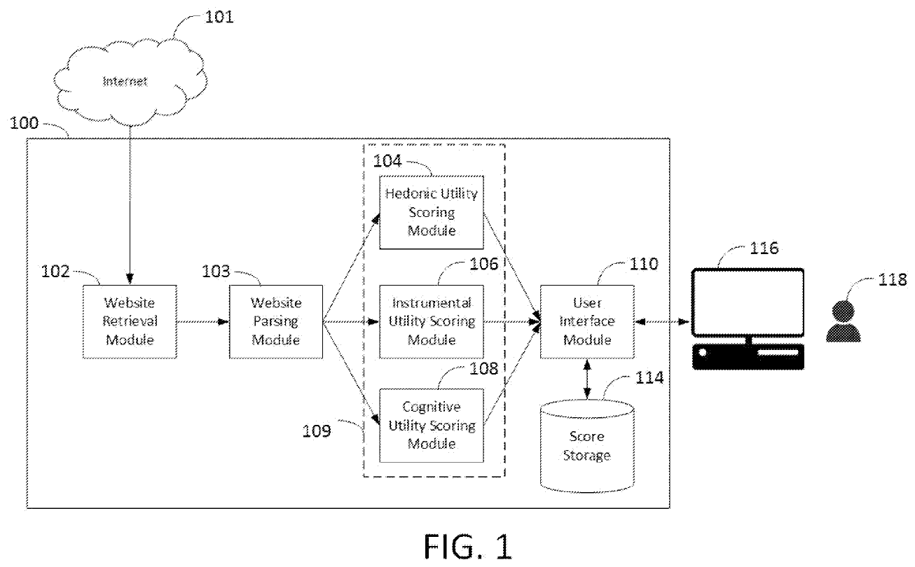

Referring to FIG. 1, a system 100 downloads webpages from the internet 101 and computes the hedonic utility (i.e., emotion score), instrumental utility (i.e., usefulness score), and cognitive utility (i.e., knowledge score) scores for each of the webpages. The system 100 presents the utility scores in a variety of ways (described in greater detail below) to a user 118 through a user interface on a computing device 116. In some examples, the system 100 includes a webpage retrieval module 102, a webpage parsing module 103, a hedonic utility scoring module 104, an instrumental utility scoring module 106, a cognitive utility scoring module 108, a user interface module 110, and a score storage 114. In some examples, the hedonic utility scoring module 104, instrumental utility scoring module 106, and cognitive utility scoring module 108 are combined into a single utility scoring module 109.

In operation, the webpage retrieval module 102 first retrieves a webpage from the internet 101 (e.g., one of many websites returned as search results from a web search). In some examples, webpage retrieval module 102 does so by downloading a base HyperText Markup Language (HTML) page, downloading all embedded objects that are included within the base HTML, (e.g., the text header, paragraph text, image and video etc.). The retrieved webpage is provided to the webpage parsing module 103, which parses the retrieved webpage into its component elements. For example, parsing is performed by identifying specific delimiters within the webpage such as HTML tags, such as paragraph text (<p>), images (<img>) etc. The system may utilize a webpage crawler or automated script to identify and parse the component elements.

The parsed component elements of the webpage are then provided to the hedonic utility scoring module 104, the instrumental utility scoring module 106, and the cognitive utility scoring module 108, (or to the utility scoring module 109) which process the component elements to determine the hedonic, instrumental, and cognitive utility scores for the webpage, respectively. Computation of the utility scores is described in greater detail below.

The hedonic, instrumental, and cognitive utility scores are provided to the user interface module 110, which stores the utility scores in a score storage 114 and presents the utility scores along with the website to the user 118 via the computing device 116. Presentation of the utility scores is described in greater detail below.

### 2 Utility Scores

### 2.1 Emotion, Instrumental, and Cognitive Utility Scores

In some examples, the hedonic utility scoring module 104, the instrumental utility scoring module 106, and the cognitive utility scoring module 108 are implemented as machine learning models trained on labeled data. As is noted above, in other examples, a single machine learning model (i.e., the utility scoring module 109) is trained on labeled data to generate all three utility scores.

Hedonic Utility (sometimes referred to as ‘Emotion’) can be defined as how positive the information on the webpage is (i.e., “How positive is the information on the webpage?”) and/or how negative the information on the webpage is (i.e., “How negative is the information on the webpage?”). Emotion can further be defined as the difference between how positive and negative the information on a webpage is. Hedonic utility is based on the idea that knowledge can induce both positive and negative affect. Knowing that one has a predisposition to certain cancers, for example, can generate sadness, despair, or fear. All else being equal, individuals are motivated to avoid information that induces negative affect and to seek information that evokes positive affect—using information to regulate emotion. Consistent with this proposition are observations that investors monitor their portfolio more frequently when they expect their worth has gone up rather than down; that monkeys select to know in advance the size of reward they are about to get; that some people refuse to receive results of medical tests they have taken and prefer not to receive information about unpleasant events.

Instrumental utility (sometimes referred to as “Actionability”) is the extent to which the information on the webpage could help guide actions and/or decisions (i.e., “Could the information on the webpage help guide actions and/or decisions?”). In general, the ability to use information to select actions that increase extrinsic rewards and help evade losses is an important driver of information-seeking. This component of the framework is found in most classic models of information-seeking. What has often been overlooked, however, is that information can also have negative instrumental value. That is, knowledge can at times cause individuals to select actions that lead to worse outcomes, while deliberate ignorance can lead to better outcomes.

Cognitive utility (sometimes referred to as “Knowledge”) is the degree to which the information on the webpage increases the participant's understanding of the topic (i.e., “Does the information on the webpage increase your understanding of the topic?”). In general, information can enhance or reduce people's sense that they understand the world around them. Information alters people's internal mental models. Mental models are a representation of concepts (for example, ‘dog’, ‘Shakespeare’, ‘mom’, ‘alien’, ‘democracy’, ‘cancer’, ‘money’, ‘self’) and the relationships among them, which are used to comprehend and anticipate reality.

### 2.1.1 Training Data

In some examples, the hedonic utility scoring module 104, instrumental utility scoring module 106, and cognitive utility scoring module 108 (or alternatively the utility scoring module 109) are trained using labeled training data. In one example, the labeled data is collected from participants who were recruited to browse and rate 5 webpages each on three dimensions: Emotion (to assess hedonic utility), Actionability (to assess instrumental utility), and Knowledge (to assess cognitive utility). Actionability was defined as the extent to which the information on the webpage could help guide actions and/or decisions (i.e., “Could the information on the webpage help guide actions and/or decisions?”). In some examples, Emotion is defined as how positive the information on the webpage is (i.e., “How positive is the information on the webpage?”) minus how negative the information on the webpage is (i.e., “How negative is the information on the webpage?”). In other examples, positive and negative Emotion scores are used separately rather than creating a composite Emotion score. Knowledge was defined as the degree to which the information on the webpage increased the participant's understanding of the topic (i.e., “Does the information on the webpage increase your understanding of the topic?”). All dimensions were rated on a 6-point scale, with 1 representing the lowest level of positive/negative emotion, actionability or knowledge, and 6 representing the highest level.

### 2.2 Model Training and Evaluation

In the case of a single machine learning model 109, the model training and evaluation process was performed following a structured sequence of steps. First, given that the Emotion, Actionability, and Knowledge scores ranged from 1 (low) to 6 (high), a binary threshold was set. The optimal overall AUC score for each dimension led us to determine a cut-off of 5 for Emotion, Actionability, and Knowledge scores. This meant that scores of 5 or higher were assigned a value of 1, while those below this threshold received a value of 0.

Following the scoring procedure, the text extracted from webpages undergoes pre-processing. This involves the removal of ‘stop words’ and the tokenization of the remaining words. The pre-processed text serves as the input variable for the model, while the binary Emotion, Actionability, and Knowledge ratings were used as the target variables.

Next, the input data is transformed into a format suitable for machine learning. In some examples, this is achieved by applying the TfidfVectorizer to the input variable, converting the textual data into a numerical matrix of Term Frequency-Inverse Document Frequency (TF-IDF) features.

Subsequently, to ensure the independence of samples, the data is first separated based on unique individuals, making certain that ratings from a specific individual either fell into the training set or the test set, but never both. This initial separation based on unique individuals ensured that there was no overlap or data leakage between the training and testing datasets at the individual level, thereby preventing individual-specific patterns or biases from influencing the model's performance.

In some examples, if there is a class imbalance in the data, sampling techniques (e.g., oversampling the minority class or undersampling the majority class) are used to address the class imbalance.)

Model training is then executed using, for example, the Light GBM or skit-learn Python packages. In some examples, three logistic regression models, dedicated to Emotion, Actionability, and Knowledge respectively, are trained using the designated training set, from which the model's feature coefficients are extracted.

Finally, the performance of the models is evaluated using the test set. For example, the eval function in the Light GBM package can be utilized, providing a robust measure of how effectively the models could predict Emotion, Actionability, and Knowledge ratings in a practical context.

The resulting model receives the component parts of a webpage as input and generates both the hedonic, instrumental, and cognitive utility scores for the webpage as output.

### 3 User Interface

As is mentioned above, the hedonic, instrumental, and cognitive utility scores are provided to the user interface module 110 and stored in the score storage 114. The user interface module 110 prepares the scores for presentation to the user 118, as is described below.

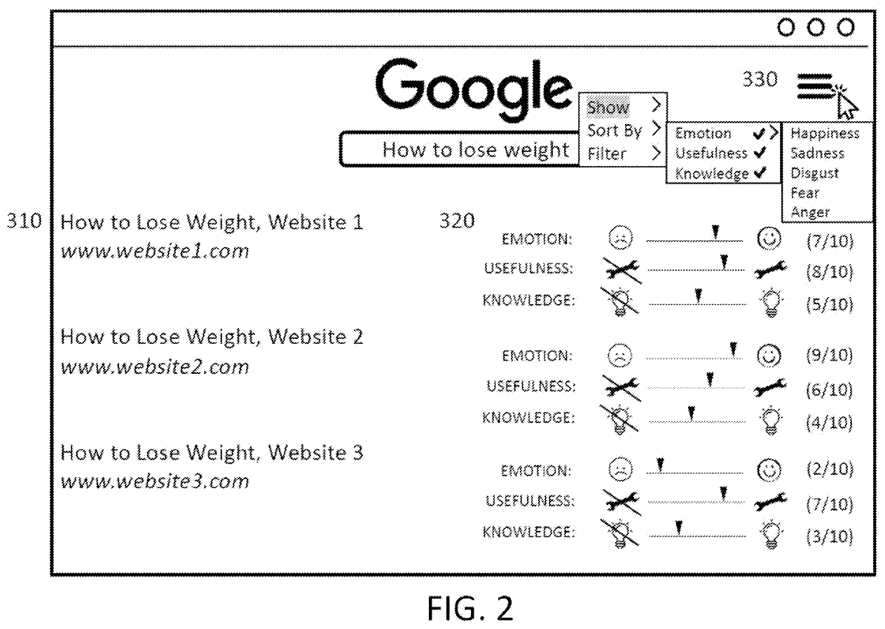

Referring to FIG. 2, in one example, utility scores are presented to the user 118 alongside search engine results. In FIG. 2, the user has searched for “How to lose weight”′ using a Google search. The search results 310 from that query are listed as different websites pertaining to weight loss. Accompanying each search result are the utility scores 320. The scores are computed in line with the process described in FIG. 1. The user can use a user interface element 330 select to present any of the following scores: (i) emotion score and/or specific emotion scores (e.g., happiness etc.), (ii) usefulness score, (iii) and knowledge score. In this illustration, the user selected to present the emotion, usefulness, and knowledge scores for each webpage. Thus, the user is a priori aware of the utility scores prior to selecting which webpage link to visit. This allows the user to optimize their web browsing by selecting the links most likely to satisfy their browsing goal. Moreover, users can avoid certain types of information (i.e., webpages that are negatively valenced (website 3), not useful (website 2), do not increase understanding (website 3).

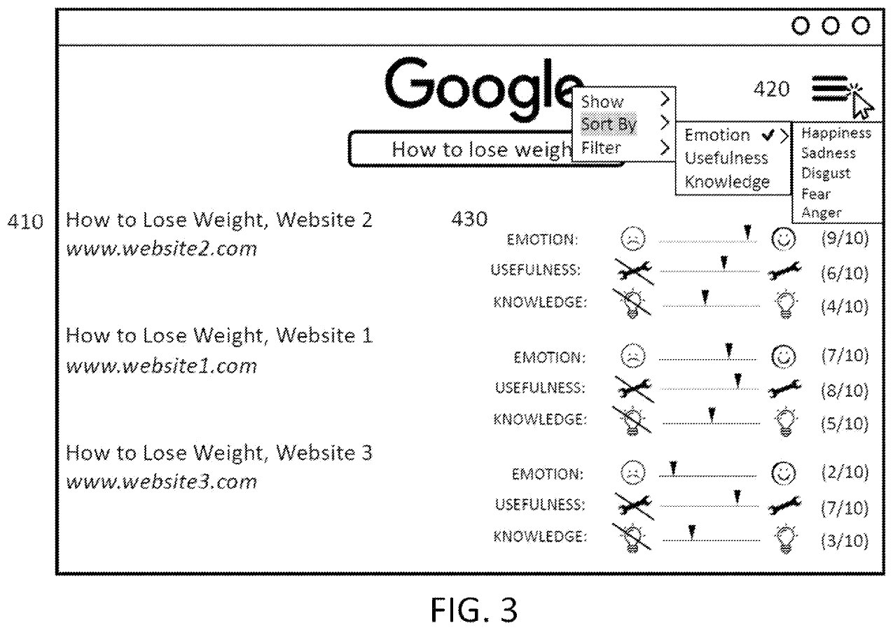

Referring to FIG. 3, in some examples, the search engine results can be reordered by the utility scores. The search engine results 410 depicted in FIG. 2 can be reordered by the emotion or specific emotion score, usefulness score, and/or knowledge score 420. In this case, the user has interacted with the user interface to reorder the search results 430 by their emotion score from most positive to most negative. Doing so increases the likelihood that users will visit a webpage most likely to satisfy their overall browsing goal, as links closer to the top of the page have been shown to attract more engagement.

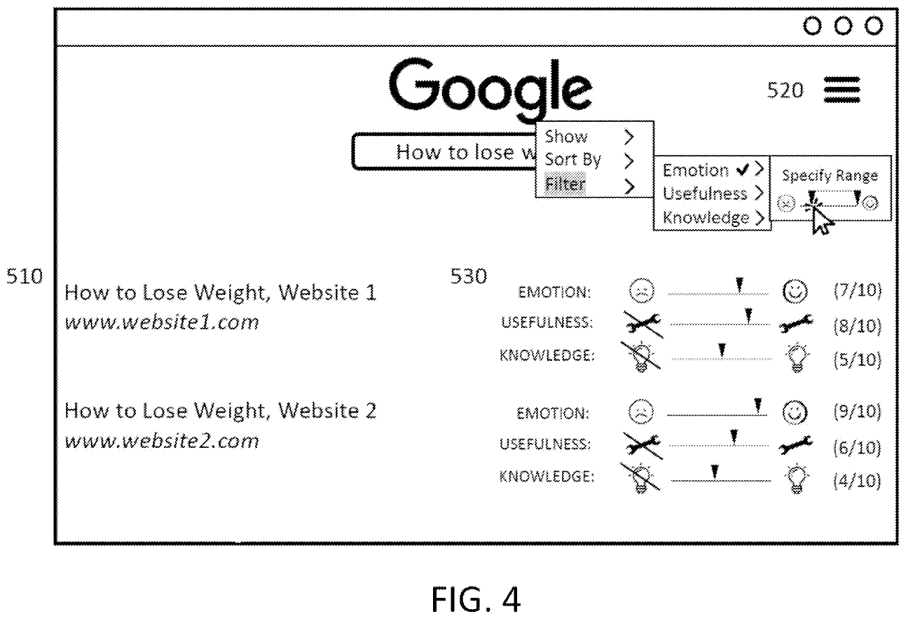

Referring to FIG. 4, in some examples, the search engine results can be filtered by the utility scores. The search engine results 510 depicted in FIG. 2 can be filtered by their emotion or specific emotion score, usefulness score or knowledge score by then removing links to webpages that are outside a predefined score range. In this case, the search engine results have been filtered by their emotion score 530, and links with low emotion score have been removed. This embodiment increases the likelihood that user will visit a webpage most likely to satisfy their overall browsing goal and avoid those that do not. Moreover, this embodiment could be particularly useful as a parental guidance tool and/or educational tool (e.g., by filtering links according to high knowledge scores).

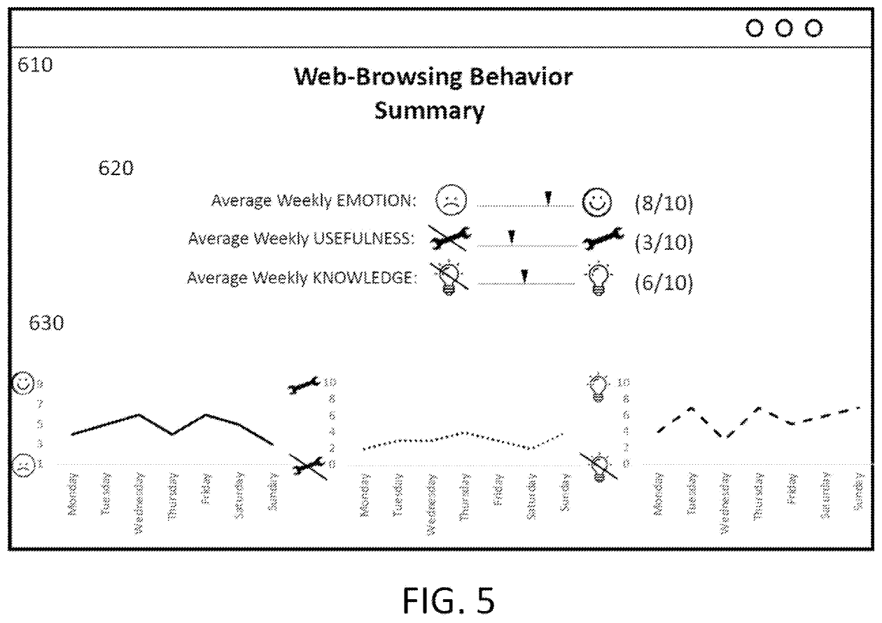

Referring to FIG. 5, in some examples, utility scores of webpages visited over time by the user are presented. A summary 610 of the utility scores can be presented to the user in different formats, for example by presenting them as an average over a set period of time 620 or presenting them as a time series 630 for a set period of time. This provides users with awareness of their web-browsing patterns, enabling users to assess the need to change web-browsing patterns.

### 3.1 Web Browser Plugin

To address the problem of detrimental effects of unwanted information, a tool in the form of a web browser (e.g., Google Chrome) plugin is developed and designed to empower users to navigate the web in a way that may improve their decision making, mental health, and understanding. Much like how people use nutritional labels to learn about the nutritional value of food before it enters their body (e.g., calories, fat content etc.), the tool provides ‘content labels’ for available webpages in a search engine results page that a user can inspect before consuming information.

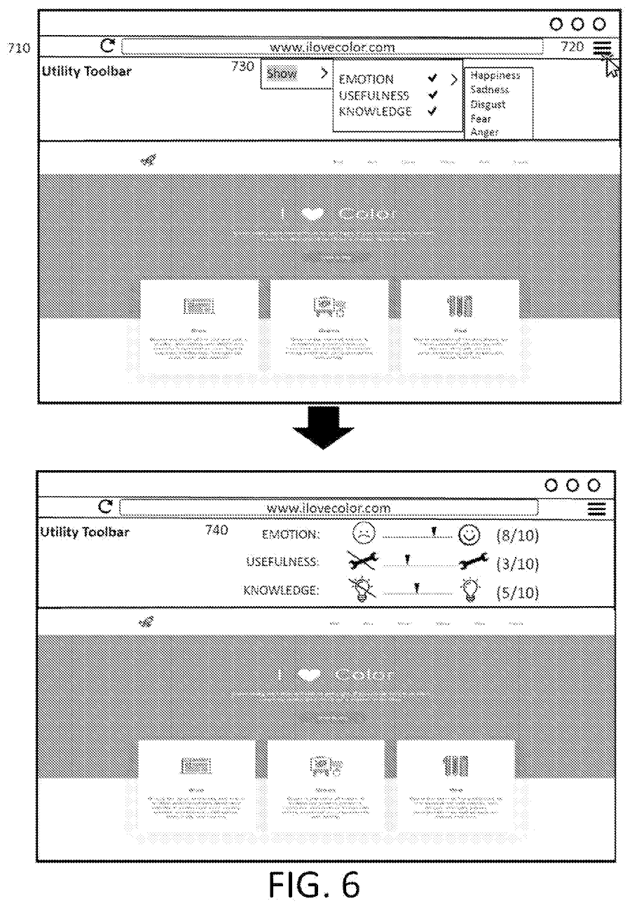

Referring to FIG. 6, in some examples, the browser plugin application presents the utility scores to the user in a toolbar 710. The toolbar 710 can be applied to the web browser, via a plugin application that adapts the general functionality of the webpage. The user can select which utility scores of the webpage they want to be displayed by first clicking the preferences button 720 located on the toolbar. In this illustration, the user selects to present the emotion, usefulness, and knowledge scores 730 of the webpage. The emotion, usefulness, and knowledge scores 740 are then presented graphically and numerically.

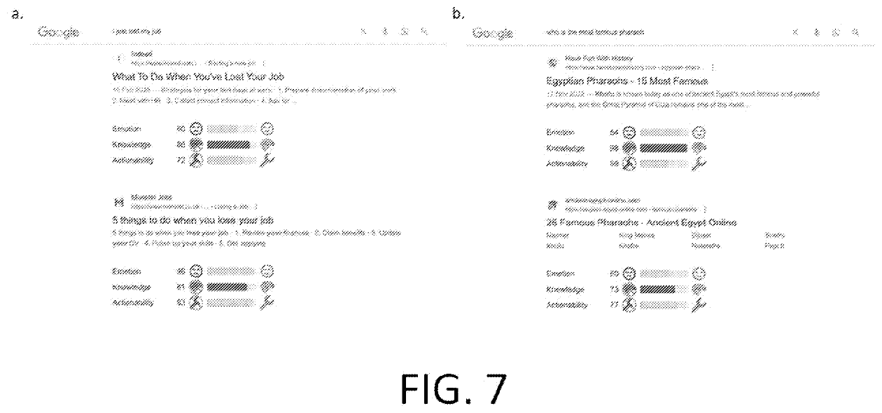

Referring to FIG. 7, the Google Chrome plugin provides scores visible in a Google search results about the above three factors [which we respectively called ‘Actionability’ (or instrumental utility), ‘Knowledge’ (or cognitive utility), and ‘Emotion’ (or hedonic utility)] of text found on webpages. Users can use these scores to improve their web-browsing experience, such that the information they consume better aligns with their goals. For instance, individuals seeking practical advice such as “I just lost my job” may prioritize information with a high ‘Actionability’ value, while those looking to deepen their understanding of a topic, for example “who is the most famous pharaoh” might prioritize webpages with a high ‘Knowledge’score.

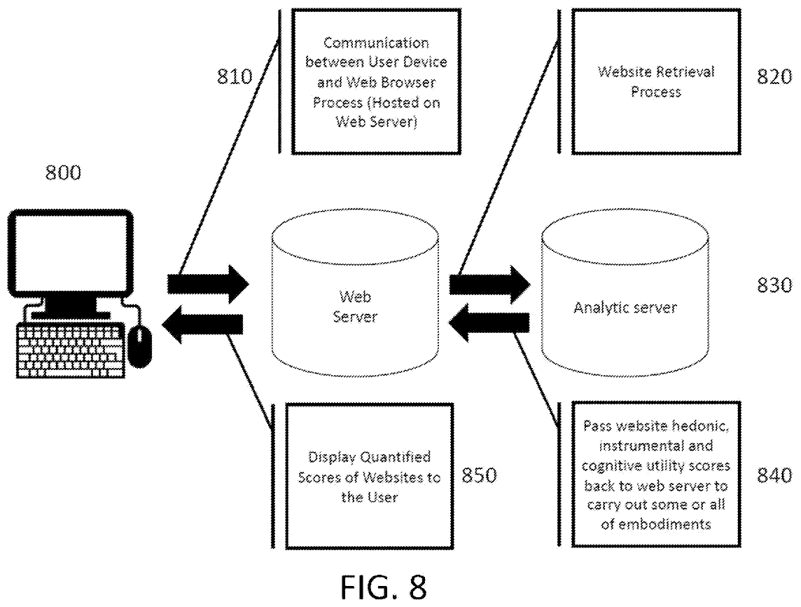

Referring to FIG. 8 a method for quantifying and presenting a set of utility scores associated with a webpage being accessed by a user via a browser process executing on the computing device is depicted. The method involves a first step 810 where the user initially communicates with a web server which in turn connects to the web browser process. Next, an analytic server 830 capable of executing the embodiments of the invention retrieves the information from the URLs that are presented to a user on the web server. The utility scores are computed for each URL in line with the process described above. The process is then executed by the server by sending the utility scores 840 back to the web browser from the analytic server and finally to a user 850.

### 4 Alternatives

While the examples described herein are in the context of web browsing (webpage content), it is noted that the techniques described herein are generally applicable to other types of content including but not limited to documents, videos, audio content, and Reddit threads, etc.

In the examples described above, the scores are presented to the user in a user interface. But it should be noted that the scores can also be stored for subsequent distribution to users, system tools (e.g., browser plugin), or third parties (e.g., search engines). In some examples, the scores are updated by repeating the process described above. In some examples, the process described above is executed on a webpage whenever content on that webpage changes, formatting of the webpage changes, or on a recurring interval basis (e.g., every day). The utility scores for each user can also be stored separately to an online server, to be used as a feedback tool of their web-browsing patterns over time.

Generally, the system and methods described above may also be employed to other types of documents including audio and video recordings and online chat threads (e.g., Reddit).

### 5 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of a program. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method comprising:
receiving data characterizing a plurality of documents comprising data associating each document of the plurality of documents with a plurality of utility scores, wherein each utility score of the plurality characterizes a different type of utility of the document to a consumer of the document;
selecting a subset of documents from the plurality of documents for presentation to a user, the selecting being based at least in part on the respective utility scores associated with each of the plurality documents; and
providing the subset of documents for presentation to the user.

2. The method of claim 1 further comprising ordering the selected subset of documents according to the respective utility scores associated with each of the plurality of documents prior to providing the subset of documents for presentation to the user.

3. The method of claim 1 wherein the plurality of utility scores includes at least two of:
a first utility score of the plurality of utility scores characterizes a hedonic utility of a document to a consumer of the document,
a second utility score of the plurality of utility scores characterizes an instrumental utility of the document to a consumer of the document, and
a third utility score of the plurality of utility scores characterizes a cognitive utility of the document to a consumer of the document.

4. The method of claim 3 wherein the hedonic utility of a document to a consumer of the document characterizes affective properties of the document to the consumer of the document including valence and emotion properties of the document to the consumer of the document.

5. The method of claim 3 wherein the instrumental utility of a document to a consumer of the document characterizes an ability of the document to guide decisions or actions of the consumer.

6. The method of claim 3 wherein the cognitive utility of a document to a consumer of the document characterizes an ability of the document to increase a knowledge or understanding of a topic related to the document.

7. The method of claim 1 wherein the selecting of a subset of documents from the plurality of documents for presentation to a user is based at least in part on user-defined desired utility scores.

8. The method of claim 1 wherein the data characterizing a plurality of documents comprises an index for a search engine.

9. The method of claim 1 wherein presenting the subset of the documents to the user includes presenting a document to the user along with its associated utility scores.

10. The method of claim 1 wherein the data characterizing a plurality of documents is determined by processing the plurality in documents in bulk to identify the utility scores for the documents.

11. The method of claim 1 wherein the data characterizing a plurality of documents is determined as new documents are received from a stream of documents.

12. A method comprising:
receiving data characterizing a plurality of documents consumed by a user;
determining, for each document of the plurality of documents, an associated plurality of utility scores, wherein each utility score of the plurality characterizes a different type of utility of the document to a consumer of the document;
determining an information consumption score, the determining including aggregating the associated plurality scores for the plurality of documents; and
providing the information consumption score for presentation to the user.

13. The method of claim 1 wherein presentation to the user includes presentation using a graphical user interface.

14. The method of claim 3, wherein the second and third utility scores are assessed by training a supervised machine learning model.

15. The method of claim 3, wherein the second and third utility scores are assessed by training different supervised machine learning models, respectively.

16. The method of claim 12 wherein presentation to the user includes presentation using a graphical user interface.
